(19) United States
(12) Patent Application Publication
(10) Pub. No.: US 2022/0136466 A1
(43) Pub. Date: May 5, 2022

(54) COMPRESSOR HOUSING OF A RADIAL COMPRESSOR, AND METHOD FOR FEEDING CHARGE AIR INTO AN INTERNAL COMBUSTION ENGINE

(71) Applicant: ABB Switzerland Ltd., Baden (CH)

(72) Inventors: Christoph Mathey, Fislisbach (CH); Bernd Albiez, Rickenbach (DE)

(21) Appl. No.: 17/432,836

(22) PCT Filed: Feb. 20, 2020
(86) PCT No.: PCT/EP2020/054506

§ 371 Date: Aug. 20, 2021

(30) Foreign Application Priority Data
Feb. 20, 2019 (EP) 19158292.3

(51) Int. Cl. F02M 31/20; F04D 29/42; F04D 29/44; F04D 29/66

(52) U.S. Cl. CPC F02M 31/20; F04D 29/664; F04D 29/441; F04D 29/4206

(57) ABSTRACT

The disclosure relates to a compressor housing of a radial compressor. The compressor housing includes a radially inner housing region which forms an axial inflow channel in an intake region of the radial compressor. The compressor housing also includes a diffusor region which adjoins the radially inner housing region. The diffusor region is designed to deflect a radial flow downstream of a compressor impeller into an axial direction counter to an inflow direction of the inflow channel. The compressor housing also includes a radially outer housing region which adjoins the diffusor region, extends axially counter to the inflow direction and provides one or more charge air manifolds.

### CROSS REFERENCE TO RELATED APPLICATIONS

This patent application is a National Stage Entry of PCT/EP2020/054506 filed on Feb. 20, 2020, which claims the benefit and priority of European Patent Application No. 19158292.3 filed on Feb. 20, 2020, the disclosures of which are incorporated by reference herein in their entirety as part of the present application.

### BACKGROUND

The disclosure relates to the area of exhaust turbochargers for pressure-charged internal combustion engines. In particular, the disclosure relates to a compressor housing of a radial compressor. Furthermore, the disclosure relates to a radial compressor having a compressor housing of this kind, to an exhaust turbocharger having a radial compressor of this kind, and to an internal combustion engine having an exhaust turbocharger of this kind. Moreover, the disclosure relates to a method for feeding charge air into an internal combustion engine, in particular by means of the compressor housing.

To boost the power of an internal combustion engine, it is standard practice nowadays to use exhaust turbochargers, having a turbine in the exhaust tract of the internal combustion engine and a compressor arranged upstream of the internal combustion engine. In this case, the exhaust gases of the internal combustion engine are expanded in the turbine. The work obtained in this process is transferred by means of a shaft to the compressor, which compresses the air fed to the internal combustion engine. By using the energy of the exhaust gases to compress the air fed to the combustion process in the internal combustion engine, it is possible to optimize the combustion process and the efficiency of the internal combustion engine.

In order to further increase the boost pressure downstream of the compressor impeller, the compressor outlet channel of the compressor housing of radial compressors is generally embodied in the form of a spiral with a cross-sectional area that increases continuously at the periphery, which then ends in a conical diffuser.

It has been found that, in the case of the spiral compressor housings known from the prior art, flow losses occur, which lead to efficiency losses of the radial compressor. Moreover, the conventional compressor housings are typically embodied in such a way that any charge air cooling is arranged separately, downstream of the compressor and thus outside the compressor housing.

### BRIEF DESCRIPTION

Embodiments of the present disclosure provide a compressor housing of a radial compressor which is improved at least in respect of one of the disadvantages of the spiral compressor housings known from the prior art. In particular, one embodiment of the present disclosure provides a compressor housing by means of which flow losses are reduced, thus making it possible to minimize efficiency losses of the radial compressor. Another embodiment of the present disclosure provides a compressor housing which is improved in respect of the ability to integrate a charge air cooling system. Moreover, another embodiment of the present disclosure provides an improved method for feeding charge air into an internal combustion engine.

Embodiment of the present disclosure provides a compressor housing of a radial compressor, and a method for feeding charge air into an internal combustion engine in accordance with the independent claims. Further aspects, advantages and features of the present disclosure can be found in the dependent patent claims, the description, and the appended figures.

One aspect of the present disclosure provides a compressor housing of a radial compressor. The compressor housing includes a radially inner housing region, which forms an axial inflow channel in an intake region of the radial compressor. In addition, the compressor housing includes a diffuser region, which adjoins the radially inner housing region. The diffuser region is designed to deflect a radial flow downstream of a compressor impeller in an axial direction counter to an inflow direction of the inflow channel. Furthermore, the compressor housing includes a radially outer housing region, which adjoins the diffuser region, extends axially counter to the inflow direction and provides one or more charge air collection chambers.

Thus, a compressor housing of a radial compressor which is improved over the prior art is advantageously provided. In particular, the compressor housing according to the present disclosure advantageously makes it possible to reduce flow losses, thereby making it possible to minimize efficiency losses of the radial compressor. Moreover, the configuration of the compressor housing described herein makes it possible to integrate a charge air cooling system. This makes it possible to achieve a more compact pressure-charging system, in particular one with fewer air connections, thus enabling the pressure-charging system to be made more compact and less complex.

Another aspect of the present disclosure provides a radial compressor having a compressor housing according to embodiments described herein.

Another aspect of the present disclosure provides an exhaust turbocharger which includes a turbine and a radial compressor according to the embodiments described herein.

Another aspect of the present disclosure provides an internal combustion engine having an exhaust turbocharger according to the embodiments described herein. In particular, the internal combustion engine includes an exhaust turbocharger according to the embodiments described herein, which is connected to an internal combustion engine via one or more exhaust lines and one or more charge air outlet openings in a vertical or horizontal alignment.

Accordingly, the use of the compressor housing described herein in combination with a radial compressor, an exhaust turbocharger having the radial compressor, and an internal combustion engine having the exhaust turbocharger, makes it possible to provide an improved radial compressor, an improved exhaust turbocharger, and an improved internal combustion engine.

Another aspect of the present disclosure provides a method for feeding charge air into an internal combustion engine. The method includes drawing in air through an axial inflow channel of a radially inner housing region of a compressor housing to provide an air flow. In addition, the method includes deflecting and expanding the air flow in a diffuser region of the compressor housing. The diffuser region is designed to deflect a radial flow downstream of a compressor impeller in an axial direction counter to an inflow direction of the inflow channel. Furthermore, the method includes cooling the air flow in a radially outer housing region, which adjoins the diffuser region, extends axially counter to the inflow direction and provides one or more charge air collection chambers.

Thus, a charge air feed method by means of which charge air cooling can be carried out within the compressor housing is advantageously provided.

### BRIEF DESCRIPTION OF THE DRAWINGS

The disclosure will be explained below by means of illustrative embodiments which are illustrated in figures and from which further advantages and modifications will emerge. Here:

FIG. 1 is a schematic sectional view of a compressor housing according to embodiments of the present disclosure;

FIG. 2 is a schematic perspective view of a compressor housing according to embodiments of the present disclosure;

FIG. 3 is a schematic perspective view of an exhaust turbocharger according to embodiments of the present disclosure; and

FIG. 4 is a flow diagram to illustrate a method for feeding charge air into an internal combustion engine according to embodiments of the present disclosure.

### DETAILED DESCRIPTION

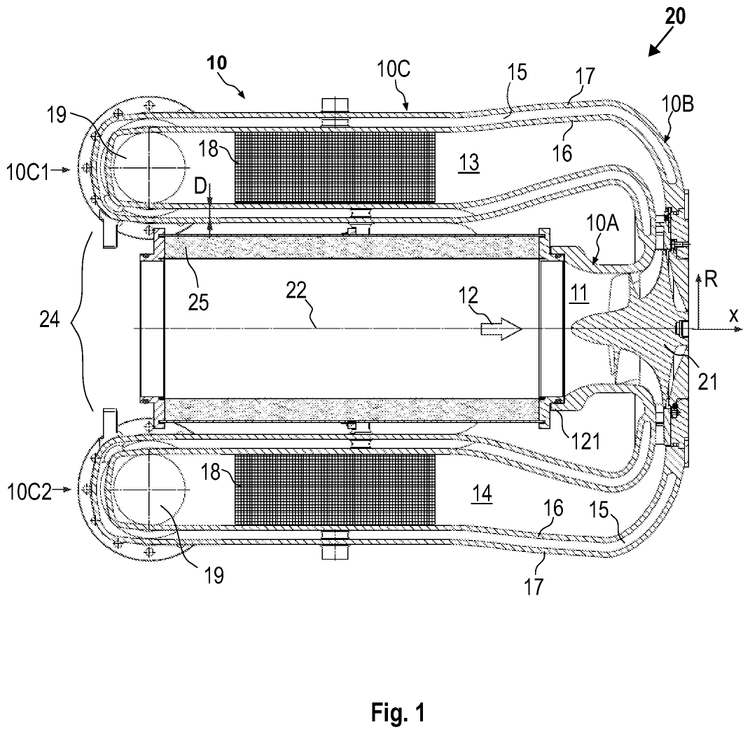

With reference to FIG. 1, a compressor housing 10 of a radial compressor according to the present disclosure is described. According to one embodiment, which can be combined with other embodiments described herein, the compressor housing 10 includes a radially inner housing region 10A, which forms an axial inflow channel 11 in an intake region of the radial compressor 20. Furthermore, the compressor housing 10 includes a diffuser region 10B adjoining the radially inner housing region 10A. The diffuser region 10B is designed to deflect a radial flow downstream of a compressor impeller 21 in an axial direction counter to the inflow direction 12 of the inflow channel 11. Furthermore, the compressor housing 10 includes a radially outer housing region 10C, which adjoins the diffuser region 10B, extends axially counter to the inflow direction 12 and provides one or more charge air collection chambers 13, 14.

Thus a compressor housing of a radial compressor which is improved over spiral compressor housings known from the prior art is advantageously provided. In particular, flow losses are advantageously reduced by the compressor housing according to the embodiments described herein. This has a positive effect on the efficiency of the radial compressor. In other words, the compressor housing described herein has the advantage that efficiency losses of the radial compressor can be minimized. Another advantage of the compressor housing described herein consists in that the configuration thereof is suitable for integration of a charge air cooling system. The integration of a charge air cooling system into the compressor housing makes it possible to achieve a more compact pressure-charging system since a separate charge air cooling system connected to the compressor housing via flow channels can be omitted. It is thus also possible to reduce the complexity of the exhaust turbocharger.

According to one embodiment, which can be combined with other embodiments described herein, at least one of the radially outer housing region 10C and the diffuser region 10B is embodied in double-shell form, thus providing an interspace 15 through which a cooling medium can flow, as illustrated by way of example in FIG. 1. In particular, the radially outer housing region 10C is embodied in double-shell form. The diffuser region 10B can be embodied partially in double-shell form or fully in double-shell form. FIG. 1 shows an illustrative embodiment in which both the radially outer housing region 10C and the diffuser region 10B are embodied in double-shell form. A double-shell embodiment of the diffuser region 10B is particularly advantageous in order to remove as much heat as possible from the charge air.

The interspace 15 is typically of continuous configuration, thus enabling a cooling medium (e.g. water) to flow in the entire interspace 15, e.g. from an axial end of the radially outer housing region 10C to a radially inner end of the diffuser region 10B. Thus, there can be a flow around a cooling medium jacket for one or more charge air collection chambers 13, 14 in order to cool the charge air. Furthermore, baffles to guide the flow of the cooling medium can be provided in the interspace 15, thus making it possible to achieve a controlled flow of cooling medium in order to remove as much heat as possible. This can have a positive effect on the efficiency of the overall system.

By virtue of the integrated cooling of the compressor housing, the compressor housing can be embodied from aluminum or an aluminum alloy, which advantageously leads to a significant reduction in weight. It is accordingly possible, according to one embodiment, which can be combined with other embodiments described herein, for the material of the compressor housing to include aluminum or an aluminum alloy. In particular, the compressor housing can be composed of aluminum or of an aluminum alloy.

As is illustrated by way of example in FIG. 1, at least one of the radially outer housing region 10C and the diffuser region 10B can include an inner shell 16 and an outer shell 17. Typically, both the radially outer housing region 10C and the diffuser region 10B have an inner shell 16 and an outer shell 17. The outer shell 17 is arranged at a distance D from the inner shell 16. To increase stability, supporting elements (e.g. struts) can be provided in the interspace 15, in particular between the inner shell 16 and the outer shell 17.

According to one embodiment, which can be combined with other embodiments described herein, at least one charge air cooler 18 is provided in the one or more charge air collection chambers 13, 14, as illustrated by way of example in FIG. 1.

In this context, it should be noted that the at least one charge air cooler is typically dimensioned in such a way that the charge air can be cooled down to the desired level at the full load point.

According to one embodiment, which can be combined with other embodiments described herein, the one or more charge air collection chambers 13, 14 has/have an internal geometry which is matched to an external geometry of the charge air cooler. In this context, it should be understood that the internal geometry of the one or more charge air collection chambers is matched to the external geometry of the charge air cooler at least in the region in which the at least one charge air cooler is arranged.

For example, the external geometry of the charge air cooler can be of cuboidal design, and the internal geometry of the one or more charge air collection chambers can be matched to the cuboidal external geometry of the charge air cooler at least in the region of the charge air cooler. In principle, other suitable external geometries of the charge air cooler and thus other correspondingly matched internal geometries of the one or more charge air collection chambers are possible.

According to one embodiment, which can be combined with other embodiments described herein, the one or more charge air collection chambers 13, 14 in each case includes/include a charge air outlet opening 19, as illustrated by way of example in FIG. 1. The charge air outlet opening(s) is (are) typically designed in such a way as to provide an outflow of the charge air in an outflow direction 23 which is transverse, in particular substantially at right angles, to the inflow direction 12.

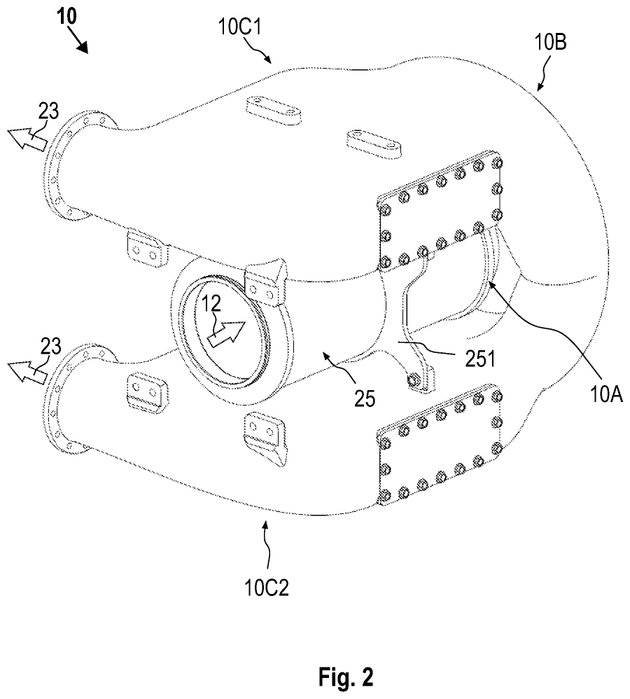

According to one embodiment, which can be combined with other embodiments described herein, the radially outer housing region 10C includes a first charge air collection chamber 13 and a second charge air collection chamber 14. The first charge air collection chamber 13 and the second charge air collection chamber 14 are each connected to the diffuser region 10B, thus providing a first charge air housing leg 10C1 and a second charge air housing leg 10C2, as illustrated by way of example in FIGS. 1 and 2.

Typically, the radially outer housing region 10C is configured in such a way, starting from the diffuser region 10B, that the charge air flow expands continuously and is deflected gently. As illustrated by way of example in FIG. 1, the charge air flow can be divided into one or more branches (e.g., the first charge air housing leg 10C1 and the second charge air housing leg 10C2) and guided to a respective charge air cooler 18.

FIGS. 1 and 2 illustrate an illustrative embodiment in which a respective charge air outlet opening 19 is arranged in the first charge air housing leg 10C1 and the second charge air housing leg 10C2. For example, the charge air outlet opening of the first charge air housing leg 10C1 can be arranged in mirror symmetry with respect to the charge air outlet opening of the second charge air housing leg 10C2, wherein the central axis illustrated in FIG. 1 represents the axis of symmetry. Typically, the central axis 22 corresponds to the axis of rotation of the compressor impeller 21.

According to one embodiment, which can be combined with other embodiments described herein, the radially outer housing region 10C has an axial extent in the opposite direction to the inflow direction 12 which is greater than an axial extent of the radially inner housing region 10A, as shown by way of example in FIGS. 1 and 2. Thus, the compressor housing is designed in such a way that the radially outer housing region 10C at least partially encloses an axial interspace 24.

FIGS. 1 and 2 show an illustrative embodiment in which the axial interspace 24 is arranged between the first charge air housing leg 10C1 and the second charge air housing leg 10C2. Typically, the axial interspace 24 is designed to accommodate a sound-absorbing element 25 on the intake side, as illustrated by way of example in FIGS. 1 and 2. As illustrated by way of example in FIG. 1, the radially inner housing region 10A typically has a connecting structure 121 on the intake side for the attachment of a sound-absorbing element 25. Furthermore, the sound-absorbing element 25 can be attached to the radially outer housing region 10C by means of a fastening element 251, as illustrated by way of example in FIG. 2.

In other words, the axial interspace 24 can be used to feed air to the inflow channel 11 of the radial compressor. The air can be fed in via a feed line, which can be designed as a sound-absorbing structure, e.g. as a cylindrical sound-absorbing element 25. A sound-absorbing intake section of this kind can advantageously be used to achieve a reduction in the sound pressure level at the intake opening of the radial compressor. This makes it possible to use a muffler with lower sound absorption, which in turn has advantages in terms of pressure loss. This thus leads to a further reduction in losses and hence to an increase in system efficiency.

According to another aspect of the present disclosure, a radial compressor 20 having a compressor housing 10 according to embodiments described herein is provided. As illustrated by way of example in FIG. 1, the radial compressor can include a sound-absorbing element 25 which is connected on the intake side to the radially inner housing region 10A and is at least partially surrounded by the radially outer housing region 10C.

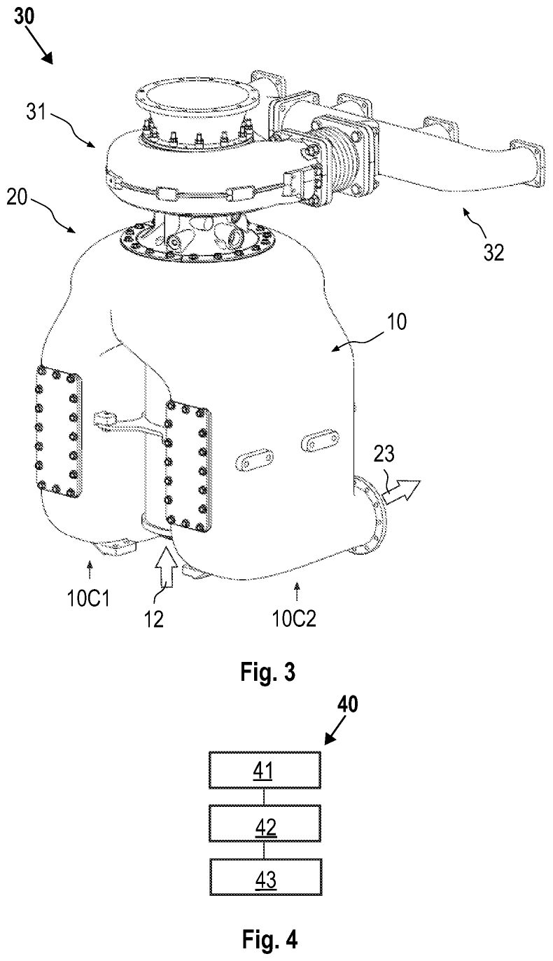

FIG. 3 shows a schematic perspective view of an exhaust turbocharger 30 according to the present disclosure. The exhaust turbocharger 30 includes a turbine 31 and a radial compressor 20 according to embodiments described herein.

According to another aspect of the present disclosure, an internal combustion engine having an exhaust turbocharger 30 according to embodiments described herein is provided. In particular, it is possible to provide an internal combustion engine in which the exhaust turbocharger is connected to an internal combustion engine via one or more exhaust lines 32 and one or more charge air outlet openings 19 in a vertical or horizontal alignment. It is thereby possible to achieve a connection which is as direct as possible between the exhaust outlet on the cylinder head and the air inlet of the internal combustion engine. Accordingly, the configuration described herein of the turbocharger, including a radial compressor having a compressor housing according to embodiments described herein, enables the turbocharger to be mounted on the internal combustion engine in a very compact way.

With reference to the flow diagram illustrated in FIG. 4, a method 40 for feeding charge air into an internal combustion engine according to the present disclosure is described.

According to one embodiment, which can be combined with other embodiments described herein, the method 40 includes drawing in air (illustrated by way of example by method block 41 in FIG. 4) through an axial inflow channel 11 of a radially inner housing region 10A of a compressor housing to provide an air flow. In addition, the method 40 includes deflecting and expanding the air flow (illustrated by way of example by method block 42 in FIG. 4) in a diffuser region 10B of the compressor housing. The diffuser region 10B is designed to deflect a radial flow downstream of a compressor impeller 21 in an axial direction counter to an inflow direction 12 of the inflow channel 11, as is apparent from FIG. 1. Furthermore, the method includes cooling the air flow (illustrated by way of example by method block 43 in FIG. 4) in a radially outer housing region 10C, which adjoins the diffuser region 10B. The radially outer housing region 10C extends axially counter to the inflow direction 12 and provides one or more charge air collection chambers 13, 14.

As described herein, at least one, in particular both, of the radially outer housing region 10C and the diffuser region 10B can be embodied in double-shell form in order to form an interspace 15. Accordingly, the cooling of the air flow can include a flow of cooling medium through the interspace 15.

Moreover, it is possible, as described herein, to provide at least one charge air cooler 18 in the one or more charge air collection chambers 13, 14. Accordingly, it is possible, in addition or as an alternative, for the cooling of the air flow to be carried out by means of the at least one charge air cooler.

In this context, it should be noted that the method described herein for feeding charge air into an internal combustion engine can be carried out using the compressor housing described herein, in particular using the radial compressor described herein.

As is apparent from the embodiments described herein, a compressor housing of a radial compressor, a radial compressor, an exhaust turbocharger, an internal combustion engine, and a method for feeding charge air into an internal combustion engine which are improved over the prior art are advantageously provided.

In particular, flow losses can advantageously be reduced by the compressor housing according to the disclosure, thereby making it possible to minimize efficiency losses of the radial compressor. Moreover, the configuration of the compressor housing described herein allows integration of a charge air cooling system. This makes it possible to achieve a more compact pressure-charging system, in particular one with fewer air connections, thus enabling the pressure-charging system to be made more compact and less complex.

In other words, with the embodiments described herein, a prior-art spiral housing of a radial compressor is replaced by the compressor housing configuration described herein. The compressor housing embodiments described herein are advantageously configured in such a way that it is possible to provide a charge air cooling system integrated into the compressor housing. In particular, the compressor housing described herein makes it possible for the compressed air to be cooled directly in the compressor housing (with a diffuser-like design) and passed to a charge air cooler without the interposition of a spiral and without a further interface. The cooled charge air can be transferred to a receiver of an internal combustion engine at the outlet of the compressor housing.

1. A compressor housing of a radial compressor, comprising:
a radially inner housing region, which forms an axial inflow channel in an intake region of the radial compressor;
a diffuser region, which adjoins the radially inner housing region and is designed to deflect a radial flow downstream of a compressor impeller in an axial direction counter to an inflow direction of the inflow channel; and
a radially outer housing region, which adjoins the diffuser region, extends axially counter to the inflow direction and provides one or more charge air collection chambers.

2. The compressor housing according to claim 1, wherein at least one, of the radially outer housing region and the diffuser region is embodied in double-shell form in order to form an interspace through which a cooling medium can flow.

3. The compressor housing according to claim 1, wherein at least one of the radially outer housing region and the diffuser region comprises an inner shell and an outer shell spaced apart from the inner shell at a distance D.

4. The compressor housing according to claim 1, wherein at least one charge air cooler is provided in the one or more charge air collection chambers.

5. The compressor housing according to claim 4, wherein the one or more charge air collection chambers has an internal geometry which is matched to an external geometry of the charge air cooler.

6. The compressor housing according to claim 1, wherein the one or more charge air collection chambers comprise a charge air outlet opening which is designed to provide an outflow of the charge air in an outflow direction which is transverse to the inflow direction.

7. The compressor housing according to claim 1, wherein the radially outer housing region comprises a first charge air collection chamber and a second charge air collection chamber, which are each connected to the diffuser region, thus providing a first charge air housing leg and a second charge air housing leg.

8. The compressor housing according to claim 1, wherein the radially outer housing region has an axial extent in the opposite direction to the inflow direction which is greater than an axial extent of the radially inner housing region, with the result that the radially outer housing region at least partially encloses an axial interspace, wherein the axial interspace is designed to accommodate a sound-absorbing element on the intake side.

9. The compressor housing according to claim 1, wherein the radially inner housing region has a connecting structure on the intake side for the attachment of a sound-absorbing element.

10. A radial compressor comprising a compressor housing comprising a radially inner housing region, which forms an axial inflow channel in an intake region of the radial compressor;
a diffuser region, which adjoins the radially inner housing region and is designed to deflect a radial flow downstream of a compressor impeller in an axial direction counter to an inflow direction of the inflow channel; and
a radially outer housing region, which adjoins the diffuser region, extends axially counter to the inflow direction and provides one or more charge air collection chambers.

11. The radial compressor according to claim 10, further comprising a sound-absorbing element which is connected on the intake side to the radially inner housing region and is at least partially surrounded by the radially outer housing region.

12. An exhaust turbocharger comprising a turbine and a radial compressor comprising a compressor housing comprising a radially inner housing region, which forms an axial inflow channel in an intake region of the radial compressor;
a diffuser region, which adjoins the radially inner housing region and is designed to deflect a radial flow downstream of a compressor impeller in an axial direction counter to an inflow direction of the inflow channel; and
a radially outer housing region, which adjoins the diffuser region, extends axially counter to the inflow direction and provides one or more charge air collection chambers.

13. An internal combustion engine having an exhaust turbocharger according to claim 12, wherein the exhaust turbocharger is connected to an internal combustion engine via one or more exhaust lines and one or more charge air outlet openings in a vertical or horizontal alignment.

14. A method for feeding charge air into an internal combustion engine, the method comprising:
drawing in air through an axial inflow channel of a radially inner housing region of a compressor housing to provide an air flow;
deflecting and expanding the air flow in a diffuser region of the compressor housing, wherein the diffuser region is designed to deflect a radial flow downstream of a compressor impeller in an axial direction counter to an inflow direction of the inflow channel; and
cooling the air flow in a radially outer housing region, which adjoins the diffuser region, extends axially counter to the inflow direction and provides one or more charge air collection chambers.

15. The method according to claim 14, wherein at least one of the radially outer housing region and the diffuser region is embodied in double-shell form in order to form an interspace, and wherein the cooling of the air flow comprises a flow of cooling medium through the interspace, wherein at least one charge air cooler is provided in the one or more charge air collection chambers and wherein the cooling of the air flow is carried out by means of the at least one charge air cooler.

16. The compressor housing according to claim 1, wherein both of the radially outer housing region and the diffuser region are embodied in double-shell form in order to form an interspace through which a cooling medium can flow.

17. The compressor housing according to claim 2, wherein at least one of the radially outer housing region and the diffuser region comprises an inner shell and an outer shell spaced apart from the inner shell at a distance D.

18. The compressor housing according to claim 1, wherein both of the radially outer housing region and the diffuser region comprise an inner shell and an outer shell spaced apart from the inner shell at a distance D.

19. The compressor housing according to claim 1, wherein the one or more charge air collection chambers comprise a charge air outlet opening which is designed to provide an outflow of the charge air in an outflow direction which is substantially at right angles to the inflow direction.

20. The method according to claim 14, wherein both of the radially outer housing region and the diffuser region are embodied in double-shell form in order to form an interspace, wherein the cooling of the air flow comprises a flow of cooling medium through the interspace, wherein at least one charge air cooler is provided in the one or more charge air collection chambers, and wherein the cooling of the air flow is carried out by means of the at least one charge air cooler.
